(19) United States
(12) Patent Application Publication
(10) Pub. No.: US 2018/0172209 A1
(43) Pub. Date: Jun. 21, 2018

(54) Apparatus and Method for the Regasification of Liquefied Natural Gas

(71) Applicant: Keppel Offshore & Marine Technology Centre Pte Ltd, Singapore (SG)

(72) Inventors: Charles P.H. Sim, Singapore (SG); Songlin Bai, Singapore (SG); Kunju Kunju Shine, Singapore (SG); Thet Khine, Singapore (SG)

(73) Assignee: Keppel Offshore & Marine Technology Centre Pte Ltd, Singapore (SG)

(21) Appl. No.: 15/128,401

(22) PCT Filed: Jul. 16, 2014
(86) PCT No.: PCT/SG2014/000332

§ 371 Date: Sep. 22, 2016

(51) Int. Cl. F17C 7/04; F17C 9/04; C10L 3/06

(52) U.S. Cl. CPC F17C 7/04; F17C 2270/0168; C10L 3/06; F17C 2221/033; F17C 2223/0161; F17C 2223/033; F17C 2223/046; F17C 2225/0123; F17C 2225/035; F17C 2227/0107; F17C 2227/0323; F17C 2227/0327; F17C 2265/05; F17C 2265/066; F17C 2270/0105; F17C 9/04

(57) ABSTRACT

This invention relates to a liquefied natural gas (LNG) regasification apparatus and method. More particularly, this invention relates to a single-compact LNG regasification apparatus that utilizes indirect heating means to build up pressure in a storage tank, vaporize LNG and superheat natural gas.

### FIELD OF THE INVENTION

This invention relates to an apparatus and a method for the regasification of liquefied natural gas (LNG). More particularly, this invention relates to a single-compact LNG regasification apparatus that utilizes indirect heating means to build up pressure in a storage tank, vaporize LNG and superheat natural gas.

### PRIOR ART

When natural gas is to be used as an energy source for powering combustion engines in vessels or vehicles, the natural gas may be safely stored in its liquefied state in cryogenic tanks on the vessel or vehicle. The LNG may then be regasified as required, before the natural gas is used to power the combustion engine of the vessel or vehicle.

There are numerous methods and systems known in the art for the regasification of LNG. Vaporizers that are typically utilized in the regasification process are Open Rack Vaporizers, Submerged Combustion Vaporizers, Intermediate Fluid Vaporizers, Shell and Tube Vaporizers or Ambient Air Vaporizers. Each of these systems uses a vaporization process whereby LNG are passed through pipes that are in contact with a heating medium. As the LNG passes through these heated pipes, the LNG absorbs heat from the pipes thereby vaporizing into a gaseous form.

However, the vaporizing systems mentioned above have various drawbacks. For example, these systems require large amounts of space, limiting these systems to land based operations whereby space is of lesser constraint. Some of these systems also typically utilize large volumes of seawater or ambient air as the heating medium for the vaporization of the LNG. The utilization of seawater has adverse environmental drawbacks to marine life, as the seawater discharged back into the ocean is at a temperature lower than the surrounding water. Further, systems that utilize ambient air or forced air drafts as heating mediums are only operable in environments with warm climates. Amongst the systems mentioned above, a closed loop Shell and Tube Vaporizer would be the most suited for use on vessels or vehicles as this system takes up the least amount of space.

Such vaporizers are disclosed in US Patent Publication No. 20130269633, published on 17 Oct. 2013, in the name of Wartsila Finland OY. This publication discloses a fuel feeding system for storing liquefied gas and feeding gaseous fuel to a piston engine. In this publication, it is disclosed that at least two pressurized cryogenic fuel tank arrangements are connected to each other and that gaseous fuel lines connect the two pressurized tanks to the engines whereby the first pressurized tank is connected to an external pressure build up system to build up the pressure within the pressurized tanks. It is further disclosed that two independent heat exchangers are utilized to vaporize the liquefied gas before the vaporized gas is directed to the piston engine.

Existing LNG regasification systems are disadvantageous because such systems are overly complex and are inherently unsafe due to the use of pressurized tanks. Hence, those skilled in the art are constantly looking for ways to devise a LNG regasification apparatus or a method that utilizes a LNG regasification apparatus that is compact in size, inherently safe to use and addresses the problems faced by existing systems.

### SUMMARY OF INVENTION

The above and other problems in the art are solved and an advance in the art is made in accordance with this invention. A first advantage of an apparatus and a method for the regasification of liquefied natural gas (LNG) in accordance with this invention is that the regasification apparatus is compact and does not require an additional heat exchanger with pressurized shell and tubes. A second advantage of an apparatus and a method in accordance with this invention is that a single external heat source may be utilized to simultaneously build up pressure within an LNG storage tank, to vaporize LNG and to superheat natural gas. A third advantage of an apparatus and a method in accordance with this invention is that the invention being a closed loop system does not have any adverse impact on the environment.

In accordance with embodiments of the invention, the LNG regasification apparatus comprises a non-pressurized tank filled with a heat thermal fluid. An auxiliary vaporizer, a main vaporizer and a heat source unit are all provided within the non-pressurized tank and the auxiliary vaporizer, the main vaporizer and the heat source unit are all in fluid contact with the heat thermal fluid in the non-pressurized tank. The auxiliary vaporizer and the main vaporizer are configured to vaporize LNG into natural gas, and the heat source unit is configured to connect to an external heat source. The auxiliary vaporizer has an inlet configured to connect to a storage tank, for receiving LNG from the storage tank, and an outlet configured to connect to the storage tank, for providing natural gas to the storage tank. Similarly, the main vaporizer has an inlet configured to connect to the storage tank, for receiving LNG from the storage tank, and an outlet configured to provide superheated natural gas.

In accordance with embodiments of the invention, the non-pressurized tank of the LNG regasification apparatus is provided with an expansion tank that has an exposed opening.

In accordance with embodiments of the invention, the auxiliary vaporizer has a first surface area and the main vaporizer has a second surface area wherein the first surface area of the auxiliary vaporizer is smaller than the second surface area of the main vaporizer.

In accordance with embodiments of the invention, the LNG regasification apparatus further includes a pump that has an inlet configured to connect to a first end of the non-pressurized tank and an outlet configured to connect to a second end of the non-pressurized tank. In this embodiment, the first end of the non-pressurized tank is located distal from the second end of the non-pressurized tank. The pump is configured to propel the heat thermal fluid in a circulating motion within the non-pressurized tank.

In accordance with embodiments of the invention, the heat thermal fluid used in the LNG regasification apparatus comprises an anti-freeze solution.

### BRIEF DESCRIPTION OF THE DRAWINGS

The above advantages and features of a method and apparatus in accordance with this invention are described in the following detailed description and are shown in the drawings:

FIG. 1 illustrating a schematic diagram of a LNG regasification apparatus in accordance with an embodiment of this invention;

FIG. 2 illustrating a schematic diagram of a LNG regasification apparatus having a heat thermal fluid circulation pump in accordance with an embodiment of this invention;

FIG. 3 illustrating a flow diagram of a process for the regasification of LNG in accordance with embodiments of the invention;

FIG. 4 illustrating a flow diagram of a process for heating an auxiliary and a main vaporizer in accordance with embodiments of this invention;

FIG. 5 illustrating a flow diagram of a process for building up pressure in a LNG storage tank in accordance with embodiments of this invention; and

FIG. 6 illustrating a flow diagram of a process for vaporizing LNG and subsequently heating the vaporized natural gas in accordance with embodiments of this invention.

### DETAILED DESCRIPTION

This invention relates to an apparatus and a method for the regasification of liquefied natural gas (LNG). More particularly, this invention relates to a single-compact LNG regasification apparatus that utilizes indirect heating means to simultaneously build up pressure in a storage tank, vaporize LNG and superheat natural gas. From hereinafter, one skilled in the art will recognize that any reference made in the description to LNG refers to liquefied natural gas and any reference made in the description to natural gas refers to LNG that has been vaporized into a gaseous form.

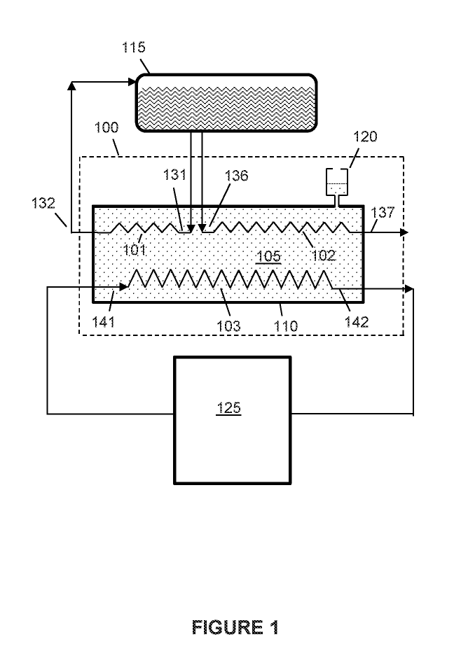

FIG. 1 illustrates a LNG regasification apparatus in accordance with an embodiment of this invention. LNG regasification apparatus 100 includes non-pressurized tank 110 filled with heat thermal fluid 105. One skilled in the art will recognize that non-pressurized tank 110 may be an enclosed receptacle or an enclosed storage chamber of any form, shape or size that is suitable for storing liquid and/or gas. In addition to the above, regasification apparatus 100 also includes auxiliary vaporizer 101, main vaporizer 102 and heat source unit 103. In embodiments of the invention, auxiliary vaporizer 101 and main vaporizer 102 may be in the form of plate and frame heat exchangers, printed circuit heat exchangers, braced plate heat exchangers, tubes, coils, helical coils, or any type of device that may be used to convert a liquid into a gas. These devices may be made from materials that have excellent heat conducting properties such as aluminium, titanium, copper or stainless steel and these devices are able to absorb heat easily thereby vaporizing any cryogenic liquids that flow within. Similarly, heat source unit 103 may be in the form of plate and frame heat exchangers, printed circuit heat exchangers, braced plate heat exchangers, a U-tube bundle, tubes, coils or hollow plates made from materials having high thermal conductivity. As a heated medium passes through heat source unit 103, heat source unit 103 will impart heat absorbed from the heated medium to an adjacent medium that is in contact with heat source unit 103.

As illustrated in FIG. 1, auxiliary vaporizer 101 and main vaporizer 102 are disposed adjacent to heat source unit 103. Further, as illustrated in FIG. 1, these components are all immersed in heat thermal fluid 105 within non-pressurized tank 110. In other words, auxiliary vaporizer 101, main vaporizer 102 and heat source unit 103 are arranged such that they are all located within non-pressurized tank 110 and are in fluid contact with heat thermal fluid 105. In this arrangement, heat source unit 103 may indirectly impart heat from a heating medium passing through heat source unit 103 to auxiliary vaporizer 101 and main vaporizer 102 via heat thermal fluid 105. One skilled in the art will recognize that the arrangement of the auxiliary vaporizer, the main vaporizer and the heat source unit are not limited to just the arrangement shown in FIG. 1. The auxiliary and main vaporizers may be arranged in various arrangements with respect to the heat source unit within the non-pressurized tank without departing from this invention provided that these three components are in constant fluid contact with the heat thermal fluid.

In an embodiment of the invention, heat thermal fluid 105 comprises an anti-freeze mixture comprising water mixed with ethylene and/or propylene glycol. Such a mixture is advantageous because it is a good heat transfer medium for efficiently transferring heat from heat source unit 103 to auxiliary vaporizer 101 and main vaporizer 102 while preventing heat thermal fluid 105 from freezing when cryogenic LNG is passed through the auxiliary and/or the main vaporizer. In embodiments of the invention, the anti-freeze mixture comprises a solution that has 30% ethylene glycol and 70% water. One skilled in the art will recognize that other types of anti-freeze solutions or mixtures may be used as the heat thermal fluid without departing from this invention provided that these other types of anti-freeze solutions or mixtures have high thermal conductivity and anti-freeze properties.

As illustrated in FIG. 1, auxiliary vaporizer 101 is provided with inlet 131 and outlet 132 while main vaporizer 102 is provided with inlet 136 and outlet 137. Inlets 131, 136 and outlet 132 are all connectable to LNG storage tank 115 while outlet 137 is used as an outlet for superheated natural gas. LNG storage tank 115 may comprise any type of type C cryogenic tank that is suitable for storing LNG and natural gas. FIG. 1 also shows that heat source unit 103 is provided with inlet 141 and outlet 142, which are all connectable to external heat source 125.

In an embodiment of the invention, external heat source 125 may be an engine or any other source of heat on a vessel or a vehicle. As the engine is being operated, the engine will produce waste heat. This waste heat may be transferred to steam, oil, hot water or any other type of heating medium that is able to convey heat from the engine to the heat source unit from which the heat is dissipated. The heating medium heated by the waste heat will then be directed to heat source unit 103 via inlet 141. As the heating medium passes through heat source unit 103, the heating medium imparts heat to heat source unit 103 thereby increasing the temperature of heat source unit 103. As the heating medium would have lost a substantial amount of heat to heat source unit 103, the heating medium exiting outlet 142 would be at a much cooler temperature than the heating medium entering heat source unit 103 at inlet 141. This cooled heating medium may then be returned to the engine to cool down the temperature of the engine. One skilled in the art will recognize that external heat source 125 is not limited to just an engine. For example, a boiler tank, may be used as the external heat source that generates heat. In other words, other types of external heat sources may be used as external heat source 125 without departing from this invention provided that the other types of external heat sources are able to provide heat. This heat may then in turn be transferred to a heating medium that is deliverable to heat source unit 103 via inlet 141 and exits heat source unit 103 via outlet 142.

In a LNG regasification operation, inlets 131 and 136 are in fluid connection with storage tank 115 to receive LNG from tank 115 while outlet 132 is connected to storage tank 115 to provide natural gas to tank 115. Inlet 141 is connected to external heat source 125 to receive the heating medium from the heat source while outlet 142 is connected to external heat source 125 to return the cooled heating medium to external heat source 125. The regasification process begins once the heating medium is provided from external heat source 125 to heat source unit 103 via inlet 141. As heat source unit 103 increases in temperature, heat source unit 103 also increases the temperature of surrounding heat thermal fluid 105 that is in fluid contact with heat source unit 103. Through natural convection, the heated thermal fluid subsequently heats auxiliary vaporizer 101 and main vaporizer 102 simultaneously. The flow of the heating medium from external heat source 125 to heat source unit 103 and back to external heat source unit 125 may be controlled using a series of control valves that may be in turn controlled by a heat control system (not shown). In embodiments of the invention, the heat control system controls the operation of the control valves to ensure that the temperature of heat thermal fluid 105 is maintained between 40° C. and 70° C.

The flow of LNG from storage tank 115 to auxiliary vaporizer 101 via inlet 131 may be controlled using a series of pressure valves that may be in turn controlled by a pressure control system (not shown). In embodiments of the invention, the pressure control system controls the operation of the pressure valves to ensure that the pressure within storage tank 115 is between 450 and 650 KPa. When LNG is introduced to auxiliary vaporizer 101 from storage tank 115 via inlet 131, the LNG absorbs heat from auxiliary vaporizer 101. The LNG then vaporizes, becoming natural gas. The natural gas is then directed back into storage tank 115 via outlet 132. As the volume of natural gas within storage tank 115 increases, this causes the pressure within storage tank 115 to gradually build up. Once the built up pressure within storage tank 115 achieves a particular pressure range, the built up pressure will cause LNG to flow from storage tank 115 to main vaporizer 102 via inlet 136. As the LNG passes through main vaporizer 102, the LNG absorbs heat from main vaporizer 102. The LNG then vaporizes, becoming natural gas.

In this embodiment of the invention, main vaporizer 102 is configured to have a larger surface area than the surface area of auxiliary vaporizer 101. Due to the increased surface area of main vaporizer 102, as compared to auxiliary vaporizer 101, main vaporizer 102 imparts additional heat to the natural gas within, as the natural gas passes through. The superheated natural gas then exits main vaporizer 102 through outlet 137. In embodiments of the invention, the surface area of main vaporizer 102 may be increased by increasing the number of coils, the length or the area of the main vaporizer that is in fluid contact with heat thermal fluid 105.

In accordance with other embodiments of the invention, LNG regasification apparatus 100 may further comprise expansion tank 120. Expansion tank 120 may be mounted on non-pressurized tank 110 as illustrated in FIG. 1. Expansion tank 120 has an opening that is exposed to the atmosphere. This opening may be used to monitor and to replenish the amount of heat thermal fluid 105 contained within non-pressurized tank 110. One skilled in the art will recognize that expansion tank 120 may be mounted on any surface of non-pressurized tank 110 without departing from this invention provided that the exposed opening of expansion tank 120 does not cause the heat thermal fluid to leak from the non-pressurized tank. During the operation of regasification apparatus 100, the volume of heat thermal fluid 105 contained within non-pressurized tank 110 will fluctuate as the temperature of heat thermal fluid 105 increases or decreases. Expansion tank 120 is provided to accommodate the fluctuation in the volume of heat thermal fluid 105 thereby ensuring that pressure does not build up within non-pressurized tank 110.

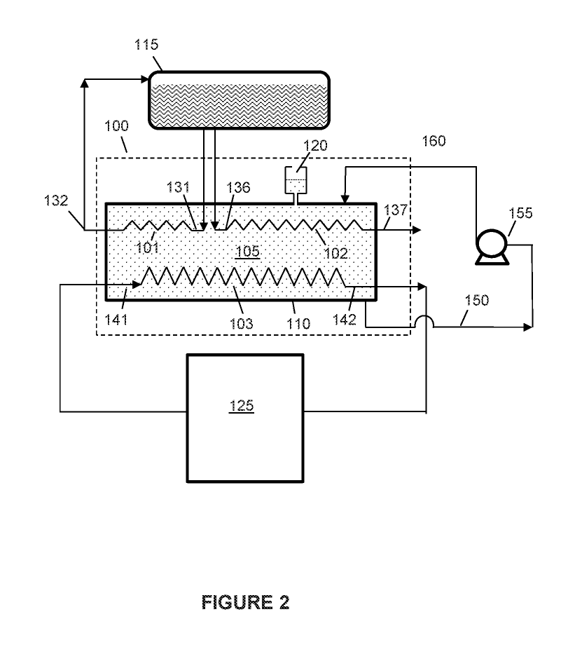

Another embodiment of the invention is illustrated in FIG. 2. In this embodiment, a circulation pump is further provided. The function of the circulation pump is to circulate heat thermal fluid 105 within tank 110. Pump 155 is in fluid connection with non-pressurized tank 110 through inlet 150, which is connected to a first end of tank 110 and through outlet 160, which is connected to a second end of tank 110. In the embodiment illustrated in FIG. 2, inlet 150 and outlet 160 are connected to opposing ends of non-pressurized tank 110, i.e. the lower end and the upper end respectively, to ensure that maximum circulation of heat thermal fluid 105 occurs within tank 110 during the operation of pump 155. One skilled in the art will recognize that inlet 150 and outlet 160 may be connected to other ends of non-pressurized tank 110 without departing from this invention provided that inlet 150 is connected to an end of non-pressurized tank 110 that is located distal from the end that is connected to outlet 160.

In the embodiment illustrated in FIG. 2, when pump 155 is activated, pump 155 draws heat thermal fluid 105 from the bottom of tank 110 and feeds the drawn heat thermal fluid to the top of tank 110. This circulating action by pump 155 causes heat thermal fluid 105 from the lower section of tank 110 to be pumped to the upper section of tank 110. The circulation cycle continuously repeats until the pump is switched of.

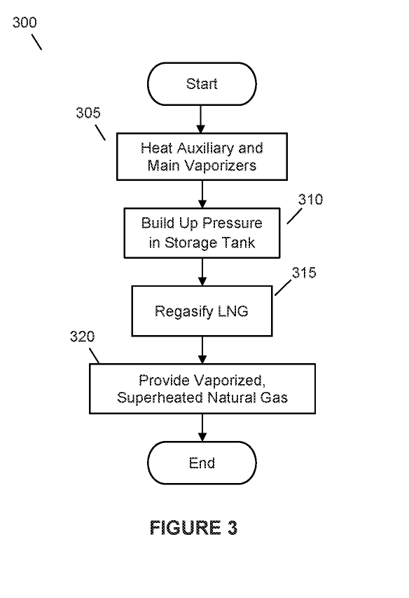

A LNG regasification process that utilizes indirect heating means to build up pressure in a storage tank, and to vaporize LNG and superheat natural gas according to embodiments of the this invention is described in the following description and in FIGS. 3-6.

FIG. 3 illustrates process 300 that is carried out by LNG regasification apparatus 100 in accordance with embodiments of this invention. Process 300 begins at step 305 by indirectly heating auxiliary vaporizer and main vaporizer simultaneously. These two vaporizers will gradually increase in temperature thereby achieving the required latent heat to vaporize LNG. Process 300 then begins the pressure build process at step 310. At step 310, the pressure within a LNG storage tank is gradually built up until a required pressure build up target is achieved. Once this pressure build target has been achieved, process 300 progresses to step 315 whereby LNG provided from the pressurized storage tank is vaporized and the natural gas is superheated. i.e. regasified. At step 320, the superheated natural gas is then provided to an outlet for further use. Process 300 then ends.

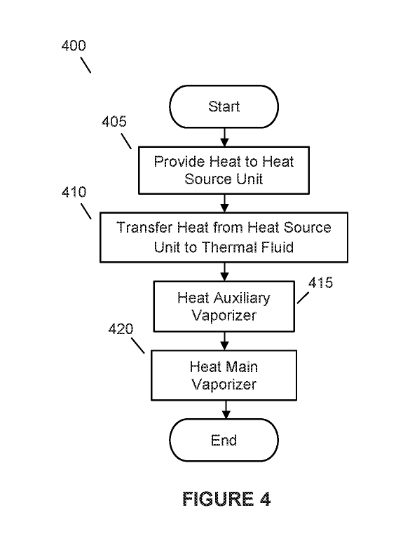

FIG. 4 illustrates process 400 that is carried out by LNG regasification apparatus 100 to heat the auxiliary and main vaporizers in accordance with embodiments of this invention. Process 400 begins at step 405 whereby heat from an external heat source is provided to increase the temperature of a heat source unit. The heat source unit absorbs the heat from the external heat source and imparts the absorbed heat to a heat thermal fluid that is in fluid contact with the heat source unit. This absorption and transfer of heat from the heat source unit to the heat thermal fluid occurs at step 410. Process 400 then progresses to step 415 and 420. At these steps, the heated thermal fluid simultaneously heats the auxiliary vaporizer and the main vaporizer that are in fluid contact with the heated thermal fluid. The temperature within auxiliary and main vaporizers gradually increases as these vaporizers absorb the heat from the heated thermal fluid. Process 400 then ends.

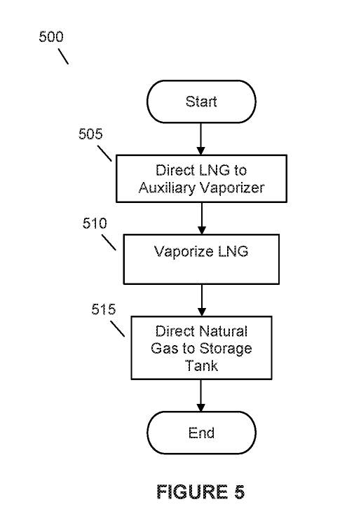

FIG. 5 illustrates process 500 that is carried out by LNG regasification apparatus 100 to build up pressure within a LNG storage tank. Process 500 begins at step 505 whereby LNG is fed to an auxiliary vaporizer from the storage tank. As the auxiliary vaporizer had absorbed heat from heated thermal fluid surrounding the vaporizer, the auxiliary vaporizer vaporizes the LNG at step 510 into natural gas. The natural gas is then directed back to the storage tank at step 515. As the amount of natural gas within the storage tank builds up, this gradually causes the pressure within the tank to build up. Process 500 then ends.

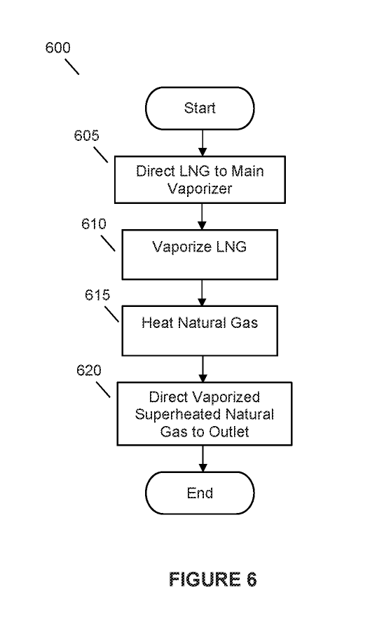

FIG. 6 illustrates process 600 that is carried out by LNG regasification apparatus 100 to vaporize LNG and to superheat natural gas. Process 600 begins at step 605 whereby LNG is forced out from a pressurized storage tank to a main vaporizer due to the pressure difference between the storage tank and the vaporizer. As the main vaporizer had also absorbed heat from heated thermal fluid surrounding the vaporizer, the main vaporizer vaporizes the LNG into natural gas as the cryogenic liquid passes through the main vaporizer. This vaporizing process occurs at step 610. As the natural gas passes through the main vaporizer, the natural gas continues to absorb heat from the main vaporizer due to the larger surface area of the main vaporizer. This process of superheating the natural gas occurs at step 615. Process 600 then progresses to step 620 whereby the superheated natural gas is directed to an outlet to be supplied for further use. Process 600 then ends.

The above is a description of a LNG regasification apparatus and process that utilizes indirect heating means to simultaneously build up pressure in a storage tank and to vaporize LNG and superheat natural gas. It is foreseen that those skilled in the art can and will design alternative embodiments of this invention as set forth in the following claims.

1. A liquefied natural gas regasification apparatus comprising:
an auxiliary vaporizer configured to vaporize liquefied natural gas into natural gas, the auxiliary vaporizer having an inlet configured to connect to a storage tank, for receiving liquefied natural gas from the storage tank, and an outlet configured to connect to the storage tank, for providing vaporized natural gas to the storage tank;
a main vaporizer configured to vaporize liquefied natural gas into natural gas and configured to heat natural gas, the main vaporizer having an inlet configured to connect to the storage tank, for receiving liquefied natural gas from the storage tank, and an outlet configured to provide heated natural gas;
a heat source unit configured to connect to an external heat source; and
a non-pressurized tank filled with a heat thermal fluid, wherein the auxiliary vaporizer, the main vaporizer and the heat source unit are provided within the non-pressurized tank and wherein the auxiliary vaporizer, the main vaporizer and the heat source unit are in fluid contact with the heat thermal fluid.

2. The liquefied natural gas regasification apparatus of claim 1 wherein the non-pressurized tank further comprises an expansion tank having an exposed opening.

3. The liquefied natural gas regasification apparatus of claim 1 wherein the auxiliary vaporizer has a first surface area and the main vaporizer has a second surface area, the first surface area being smaller than the second surface area.

4. The liquefied natural gas regasification apparatus of claim 1 further comprising:
a pump having an inlet configured to connect to a first end of the non-pressurized tank and an outlet configured to connect to a second end of the non-pressurized tank, the first end being located distal from the second end, wherein the pump is configured to propel the heat thermal fluid in a circulating motion within the non-pressurized tank.

5. The liquefied natural gas regasification apparatus of claim 1 wherein the heat thermal fluid comprises an anti-freeze solution.

6. A method for regasifying liquefied natural gas using a regasification apparatus having a non-pressurized tank filled with a heat thermal fluid, wherein an auxiliary vaporizer, a main vaporizer and a heat source unit are provided within the non-pressurized tank and the auxiliary vaporizer, the main vaporizer and the heat source unit are in fluid contact with the heat thermal fluid, comprising the steps of:
heating the auxiliary vaporizer and the main vaporizer simultaneously using the heat source unit and the heat thermal fluid;
building up pressure in a storage tank using the auxiliary vaporizer;
regasifying liquefied natural gas provided from the storage tank using the main vaporizer; and
providing the regasified natural gas to an outlet.

7. The method of claim 6 wherein the step of heating the auxiliary vaporizer and the main vaporizer comprises the steps of:
heating the heat source unit using an external heat source;
providing heat from the heat source unit to the heat thermal fluid to increase the temperature of the heat thermal fluid;
heating the auxiliary vaporizer using the heated heat thermal fluid; and
heating the main vaporizer using the heated heat thermal fluid.

8. The method of claim 6 further comprising the step of circulating the heated heat thermal fluid within the non-pressurized tank.

9. The method of claim 6 wherein the step of building up pressure in the storage tank comprises the steps of:
providing liquefied natural gas from the storage tank to the auxiliary vaporizer through a first path;
vaporizing the liquefied natural gas in the auxiliary vaporizer into natural gas; and
providing the natural gas to the storage tank.

10. The method of claim 6 wherein the step of regasifying liquefied natural gas from the storage tank using the main vaporizer comprises the steps of:
providing liquefied natural gas from the storage tank to the main vaporizer through a second path;
vaporizing the liquefied natural gas in the main vaporizer into natural gas; and
heating the vaporized natural gas in the main vaporizer.
